(19) United States
(12) Patent Application Publication
(10) Pub. No.: US 2006/0179134 A1
(43) Pub. Date: Aug. 10, 2006

(54) Device, method, and system for module level network supervision

(75) Inventors: Dan Shemesh, Jerusalem (IL); David Sayag, Tel-Aviv (IL)

Correspondence Address: Martin D. Moynihan;PRTSI, Inc., P.O. Box 16446, Arlington, VA, 22215, US

(73) Assignee: Enure Networks Ltd., Herzlia Pituach (IL)

(21) Appl. No.: 11/349,116

(22) Filed: Feb. 8, 2006

Related U.S. Application Data
(60) Provisional application No. 60/651,071, filed on Feb. 9, 2005.

(51) Int. Cl. G06F 15/173

(52) U.S. Cl. 709/223

(57) ABSTRACT

Apparatus for module level management of a network having a plurality of network devices, comprises, supervisory layers at the module units on a plurality of network devices for supervising expected communication behavior thereat. Expected communication behavior includes protocol and interface definitions and the like. The supervisory layers detect deviations from expected communication behavior at the self contained modules. As a result, devices behave in an expected way and are less likely to cause the kinds of problems which easily escalate on networks. Furthermore, causes are dealt with before they can develop into symptoms.

### RELATED APPLICATIONS

The present application claims priority from U.S. Provisional Patent No. 60/651,071, filed on Feb. 9, 2005, the contents of which are hereby incorporated by reference.

### FIELD AND BACKGROUND OF THE INVENTION

The present invention relates to an apparatus and a method for module level network supervising and, more particularly, but not exclusively to supervising units that are placed at modules on individual network devices to monitor expected behavior of the modules and identify and correct module errors.

In recent years, high speed home and Small Office Home Office (SOHO) networks utilizing infrastructure such as ADSL and Cable Modem have become increasingly more complex. Many homes already include more than one Personal Computer (PC) often connected utilizing a communication network such as WiFi wireless LAN. In addition, peripherals such as Webcams, printers, routers and other devices are being added at an increasing pace. The home networking infrastructure is becoming even more critical with the new services provided to the home, such as IPTV and VoIP, that require continuous top performance to succeed. Customized networks with special standards and conditions are also possible.

Residential and SOHO Broadband service is particularly challenging for service providers, as it requires complex technical configuration and management in a predominantly non-technical service environment. The proliferation of complex home networking exaggerates even further the disparity between the technical knowledge required to manage the home network environment and the technical naiveté of the subscriber. Typically service providers use call centers to support subscribers. Residential and SOHO Broadband subscribers generate tremendous volumes of support calls every day.

For the most part, these calls are a result of network service failure since the home network service components (PCs, modem, router, Wi-Fi, VPN, firewall, IPTV service, VoIP service etc) are located in a non professional environment. Network components may be positioned haphazardly, inadvertently re-adjusted, and used by more than one user for different purposes. Hence the residential environment is constantly exposed to incorrect or incomplete hardware or software configurations, physical disconnections, driver file corruptions, etc.

With each new subscriber, the Broadband, IPTV or any other modern Service Provider is saddled with activation and subscriber management costs that continue throughout the customer's lifecycle. Furthermore, the user's experience with the call center help desk is often negative, characterized by long wait times where problems are often solved inadequately. Consequently, users may elect to accept reduced performance, and may not be able to fully utilize the home network potential—hurting both user satisfaction and the service provider's potential revenue.

Larger networks, such as enterprise networks, although perceived as a different arena, suffer from similar management issues, as extremely higher complexities may overwhelm even the best current tools. Even the most advanced tools in this arena, such as EMC's SMARTS division's technology, deal with statistical distributions of symptoms, trying to estimate the root causes.

Current methods are based on the Symptom→Cause→Action sequence. In a networked environment, this means that typically problems propagate rapidly or otherwise and generate symptoms and symptom avalanches in large numbers, thus causing service interruptions in areas far from the inception point. Unfortunately the problem is not noticed until the symptoms appear, by which time the problem has propagated far from the cause. Consequently, finding the inception location is not easily possible, making correction expensive, inefficient and many times incomplete. That is to say, from the symptom it is difficult to find the cause, and too late to prevent disruption to the network. That is, whatever the root cause of the problem, the same symptoms will appear.

Therefore, there is an unmet need for, and it would be highly useful to have, a system and a method that overcomes the above drawbacks.

### SUMMARY OF THE INVENTION

According to one aspect of the present invention there is provided an apparatus for supervision on a network having a plurality of network devices, the network devices having at least one module, the apparatus comprising; supervisory layers at said network modules for supervising at least one member of the group consisting of configuration and expected behavior of a respective module, said supervisory layers configured to detect deviations from said member at said network modules.

According to an additional aspect there is also provided an apparatus for supervising a module operating a protocol or interface standard to communicate with other modules, the apparatus comprising:

a supervisory layer configured about said module for supervising at least one member of the group consisting of configuration and expected behavior of said module, said expected member being defined in terms of said protocol or interface standard, said supervising behavior being configured to react to deviations from said expected member, thereby to manage said module.

According to an additional aspect there is also provided a method for supervising a network comprising; defining at least one member of the group consisting of configuration and expected behavior at modules on devices on said network, and supervising conformity of said modules with said expected member on said network. Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected stages of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a simplified diagram illustrating a generalized embodiment of the present invention;

FIG. 1B is a schematic block diagram of multiple supervisory units at multiple modules on a network device according to a preferred embodiment of the present invention;

FIG. 1C is a simplified diagram illustrating the device and supervisory layer of FIG. 2 in greater detail;

FIG. 2 is a simplified diagram illustrating application of the present embodiments to a network node having two different devices;

FIG. 3 is a simplified flow chart illustrating a procedure for installing a supervisory layer according to embodiments of the present invention at one or more modules on a device network;

FIG. 4 shows a typical home network as may be managed in accordance with the present embodiments;

FIG. 5 is a simplified block diagram illustrating the application of a supervisory layer over the network of FIG. 4;

FIG. 6 shows the same network as in FIG. 4 except that a break is introduced between the router and the third PC;

FIG. 7 is parallel to FIG. 5 and shows that trees 70, 72, and 76 remain connected and tree 74 is isolated but is able to continue functioning;

FIG. 8 illustrates a procedure for fixing an error identified by the supervisory layer; and

FIG. 9 is a simplified diagram illustrating the structure of a typical container.

### DESCRIPTION OF THE PREFERRED EMBODIMENTS

The present embodiments provide an apparatus and a method for managing a network comprising a plurality of network devices, where each device contains at least one, or a plurality of modules. Supervision of the network is at the level of the individual modules. Each module may have a different technology or associated operating system or driver. Modules may represent different layers of the network, or combination of layers, including physical, application and any other level. A supervisory layer is provided at each such module to ensure expected operating behavior. The expected behavior may be based on a protocol used by the device or module or on an interfacing standard used by the device or module, and deviations from the expected behavior are either automatically corrected at the module or device or the user is prompted to provide permission to correct the deviation, or the user is directed to a specific corrective action (e.g., reconnect a disconnected cable). The present embodiments of the invention typically identify the causal issues leading to deviations from normal network operation at the point of inception, that is at the individual modules on each network device where the problem begins.

As a result, the present embodiments break away from symptom based management of the network and work directly on the root causes at the point and time of inception.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

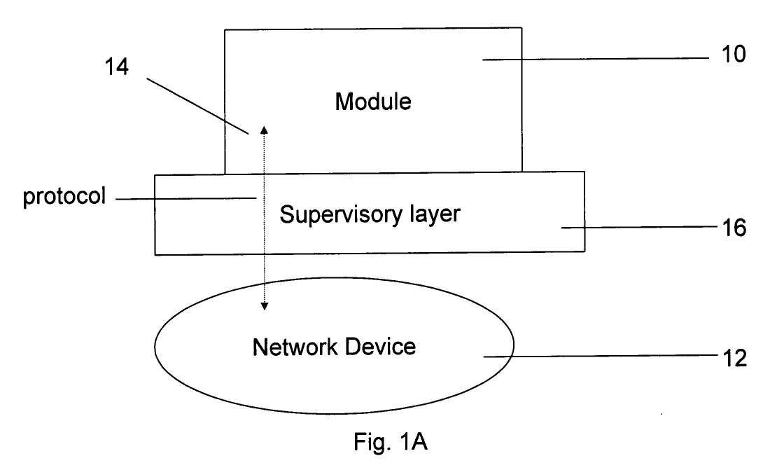

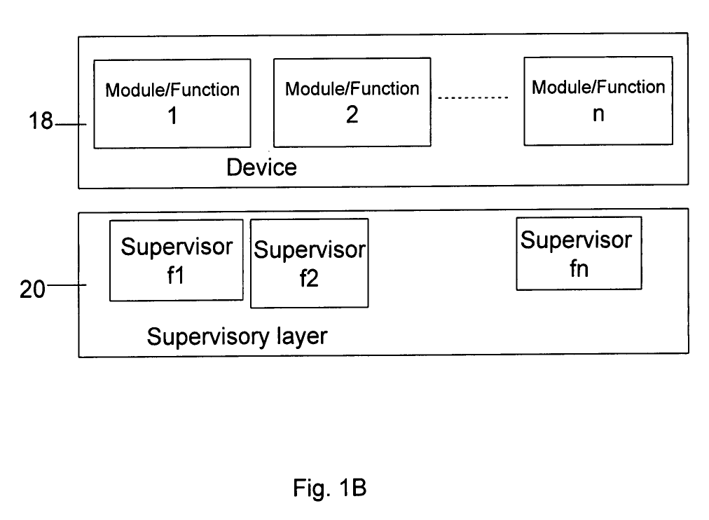

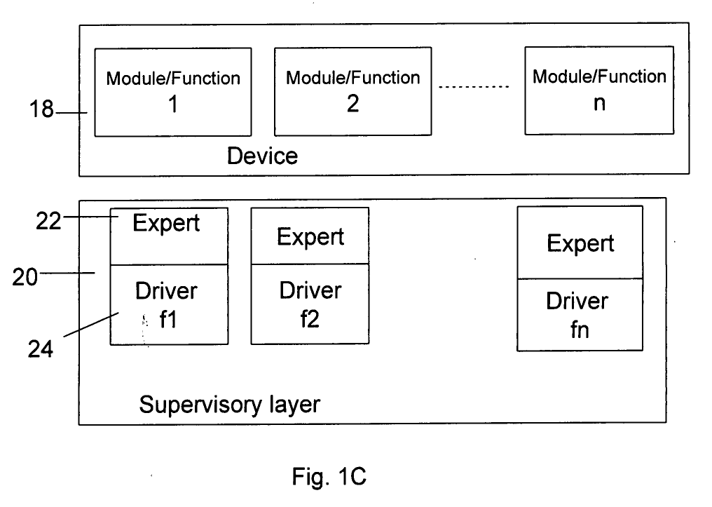

Reference is now made to FIG. 1A, which is a simplified diagram illustrating a generalized embodiment of the present invention. A module 10 is connected to a network via device 12. The module communicates with the network as indicated by arrow 14 and the communication uses a particular protocol. A supervisory layer 16 is placed over the module 10. The supervisory layer knows the protocol and contains information about the specific module. The supervisory layer monitors communications settings and work set-ups and ensures that the communication with the network is in accordance with the defined protocol and set-up and with any idiosyncrasies of the specific device. The supervisory layer preferably does not concern itself with general functioning of the device but does concern itself with communication function and with the actual communication data being produced. In the present embodiments, it is appreciated that some or all of the supervisory layers may physically reside at a device in the network such as a PC, which has the capacity to run such layers, rather than actually at the module being supervised. In such a case, a representation of the supervised module exists at the PC or like controlling network device.

Should the module deviate from expected behavior then remedial action is taken, as will be explained below.

Network problems mostly arise from individual modules on network devices. Thus the use of supervisory layers at individual modules ensures that many network problems are noticed and dealt with at their inception, rendering the network as a whole far more stable. Users have much less need to use call centers and the call centers are saved from the almost impossible task of trying to find out remotely which one of numerous devices connected to a network is causing the symptoms complained of.

Reference is now made to FIG. 1B which shows how the principle of FIG. 1A may be applied to a communication device having multiple functions, each at a self contained module as described in FIG. 1A. Device 18 has a series of communication functions, function 1 . . . function n. Device 18 further has a supervisory layer 20 which includes separate supervising units, supervisor f1 . . . supervisor fn, each dedicated to one of the functions of the device. Each communication function typically is a self contained module and has a particular protocol or interface standard and the supervisor layer is able to provide expert control for each function individually.

Reference is now made to FIG. 1C, which is a simplified diagram illustrating the device and supervisory layer of FIG. 1B in greater detail. Parts that are the same as in FIG. 1B are given the same reference numerals and are not referred to again except as necessary for an understanding of the present embodiments. In FIG. 1C, each of the supervisory units is of modular construction and comprises two parts, an expert part 22 and a driver part 24. The expert 22 contains the common information for the particular protocol or function or standard. More particularly, the expert is a generic per technology component in that it contains expert knowledge regarding that technology. The expert detects, analyzes and resolves failures, and communicates with peer experts. The driver part contains device specific information, thereby allowing the expert to communicate with the module, or the function on the module.

Using such a modular construction it is possible to construct experts for individual protocols or standards, such that the experts contain all of the common information relating to the protocol. The expert is not sufficient for dealing with specific modules and functions on those modules, and the missing information, which is information about the specific device containing this specific module instance, is provided in the driver. The aim is to provide as much information as possible on the expert, since the expert is constructed once only for the same protocol, thereby rendering the driver as small as possible. The driver on the other hand has to be constructed separately for different module types, and therefore it is particularly advantageous to keep the driver small.

The supervisory units may be configured to supervise network modules having standards and protocols customized for a particular network. A network protocol customized for a particular network allows for increased security since it is not generic and thus penetrable by intruders from the outside.

In operation, the supervisory layer manages the communication functions of the module. At times the supervisory layer detects a deviation of a given function from the definitions in its expert that is a deviation from its expected behavior. The supervising layer then takes one of a number of courses of action. It may amalgamate the deviation with other deviations and report to a client program. It can fix the problem directly via correction functionality if it knows how, or it may report the problem to a user, preferably with recommendations. The correction functionality may correct the error directly, as mentioned, in which case it is configured to automatically carry out error correction with complete transparency to the user. Alternatively, the correction unit may prompt the user to authorize a correction. The user can be prompted to press a button to select automatic repair of the failure, or may be allowed to select manual repair. Alternatively, when the problem is physical or user correctable, such as a disconnection of the cable between the PC and the modem, the correction functionality may illustrate the problem issue to the user and show the user how to manually carry out the repair, such as connect the cable.

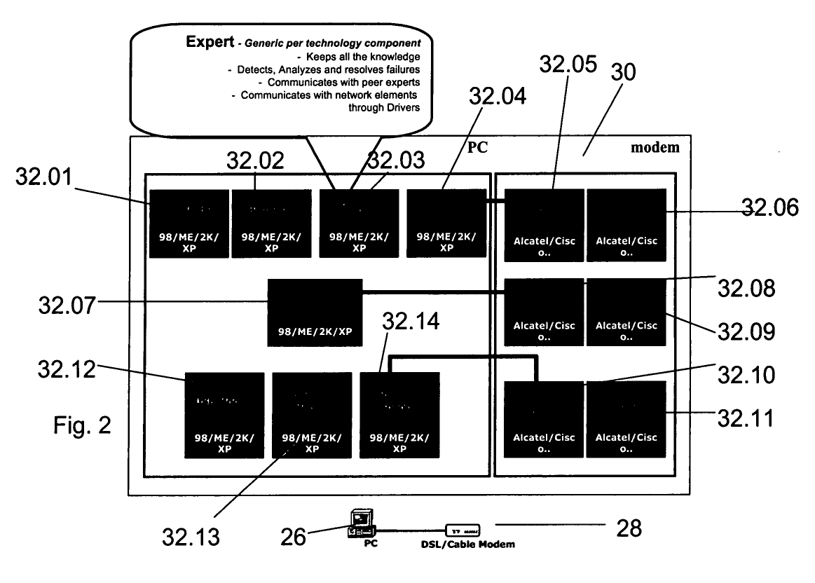

Reference is now made to FIG. 2, which is a simplified diagram illustrating application of the present embodiments to a network node having two different devices. The two devices are a PC 26 and a modem 28. Such a pairing of devices is fairly typical for a home network. The illustration shows in block diagram form a supervisory layer 30 in accordance with the present invention for which supervisory units are applied to each communication function on the PC and each communication function on the modem.

It will be noted that layer 30 comprises numerous supervisory units 32.01 . . . 32.14, which supervise modules on the PC at the user application level including the SLA verifier 32.01, browser 32.02, email 32.03, and dialer 32.04. At an equivalent level on the model are provided PPTP 32.05 and PPPoA 32.06 supervisory units. At a lower level is provided a TCP/IP supervisory unit 32.07 on the PC and both TCIP/IP 32.08 and ATM supervisory units 32.09 at the modem.

At the lowest level the PC has a USB modem supervisory unit 32.12, an internal modem supervisory unit 32.13 and a network adaptor 32.14. At the same lowest level the modem has a network adaptor supervisory unit 32.10 and a DSL supervisory unit 32.11.

The grouping of supervisory units in a layer in relation to a module or group of modules that work together at a network device is known as a container. Within the container there are both experts and drivers, the experts within the container hold generic technology knowledge that is not specific to the vendor of the individual module. The expert detects, analyzes, and resolves failures and communicates with peer experts. Any deviation from the expected protocol or standard is immediately detected by the expert as explained.

In contrast to the expert, which contains expert knowledge applicable over a broad range of like elements, the driver supervises module specific information. The drivers at each module enable communication between the module or the particular functionality of the module, and the expert, as they handle vendor specific, module specific and operating system specific tasks. The driver is configured such that it supervises defined behavior data for the particular module type on which it is installed.

Again referring to FIG. 2, the TCP/IP supervisory unit 32.07, which is part of the PC 26, is connected to the TCP/IP supervisory unit 32.08 of the modem, and both supervisory units adhere to a common communication standard that makes communication possible between them. Such communication allows for the case that one of the two supervisory units 32.07 and 32.08 spots a deviation for which a correction is needed at the other unit. If, for example, the TCP/IP supervisory unit 32.08 senses a setting in the modem TCP/IP module which is not allowed by the standard, or does not fit the other TCP/IP unit although both settings comply to the standard, the PC TCP/IP supervisory unit 32.07 may initiate a corrective action for example at the PC 26 that returns the TCP/IP settings within modem 28 to their proper values. As explained above, the correction is accomplished either automatically or upon the user clicking on an appropriate soft key.

For example, the PC TCP/IP supervisory unit 32.07 may detect a full duplex setting, while the TCP/IP modem supervisory unit 32.08 may detect half duplex. The proper setting is full duplex, but the change in settings at the modem requires the intervention of the modem driver on the PC 26, which itself is supervised by supervisory unit 32.13. The correction thus has to be made at the PC.

It is noted that both supervisory units may actually reside on the PC, meaning that the TCP/IP modem module is actually supervised at the PC.

In addition, the supervising unit may be configured to notify the user of attempted unauthorized access. This is because unauthorized access generally attempts to defeat a protocol, or a certain set-up that requires authorization. For example, a WiFi network can be either open for every user within range or request an authorization and therefore can be detected by a supervising unit that looks for protocol—enabled authorization.

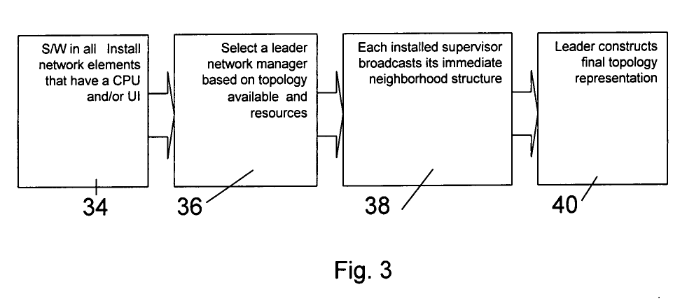

Reference is now made to FIG. 3, which is a simplified flow chart illustrating a procedure for installing a supervisory layer according to embodiments of the present invention at one or more modules on a network device. In a stage 34 software for the control layer is installed via any network device that has a user interface with a central processing unit. In stage 36 one of the devices having a CPU is selected by the software as the network leader for centralizing communications. The leader is selected according to resource availability and network topology. In stage 38 each installed supervisor broadcasts details of its immediate neighborhood structure and then the leader constructs a final topology representation of the network as a whole. Knowledge of the network as a whole allows the network leader to better understand data it receives from the supervisory layers over the network and allows the leader to report the data more correctly to the user.

The supervisory units, through their expert parts, are able to communicate between themselves according to specific standards, for example, according to the OSI network architecture or specific needs of PC's or other devices and applications. As mentioned above, the experts also communicate with the individual modules through the specific driver parts. Expert-installed mutual connection information, as explained above, is based on both standards and specific configurations, making the communication relatively stable and product agnostic.

Certain networks are TCP/IP based. The embodiments would view such a network and its service devices (such as the modem, router and the PC) as a typical TCP/IP model network. The PC, as a network device, specifically implements all the layers of the TCP/IP model. In order to function properly, all the conditions of a standard TCP/IP environment (protocols and interfaces) must function properly between the different devices. The embodiments thus approach a residential networking environment as a standard network in which the PC is a network device as are the modem and router. Any software or hardware, logical or physical failure in the PC can be related to a specific network layer, protocol or interface malfunction and can be handled according to network standard definitions. Based on such a model, the present embodiments provide decision-making algorithms which can identify and correlate any failure in any service component regardless of the service component types or of the device vendors.

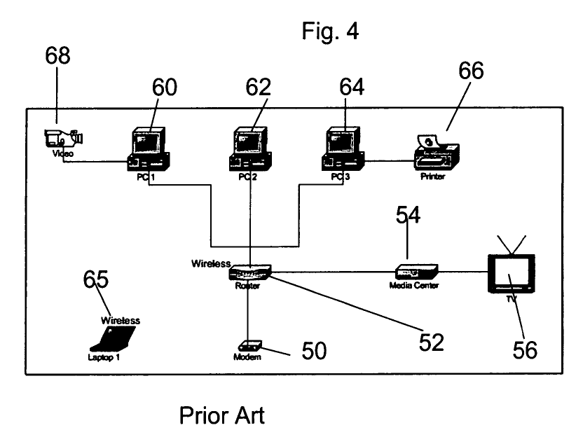

The embodiments approach the PC in a defined, segmented manner—relating to the networking aspects and other applications (such as email or security) of the PC device, thus ensuring that PC management in the network domain is finite and solvable. That is to say the different functionalities of the PC are supervised by different supervisory units, as explained above. FIG. 4 shows a typical home network as may be managed in accordance with the present embodiments. In FIG. 4 a modem 50 is connected to a router 52 which includes wireless functionality. The router is connected to a media center 54 and TV 56. Three PCs 60, 62 and 64 are connected to the network as is a laptop 64, which is connected via a wireless connection. A printer 66 and a video camera 68 are connected via the PCs. The network comprises devices which are likely to be found in the domestic environment and nevertheless has plenty of potential for malfunction due to the large number and variety of devices and the scale of the network. Furthermore the devices are not such that a remote call center is likely to know much about them.

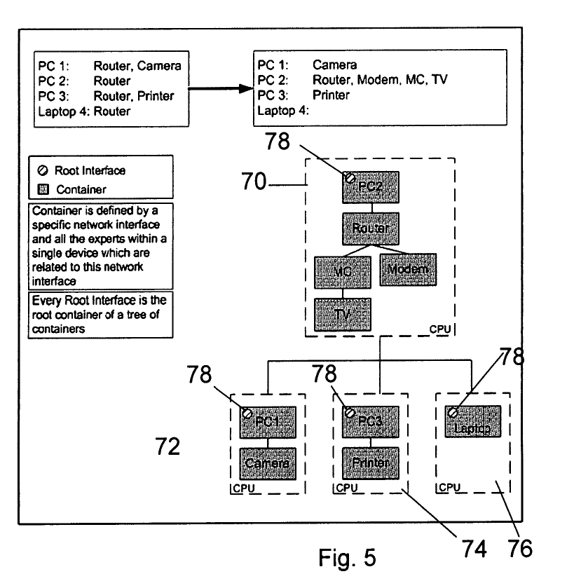

Reference is now made to FIG. 5 which is a simplified block diagram illustrating the application of a supervisory layer over the network of FIG. 4. Each physical device in the network is provided with a container of supervisory units. It will be recalled from FIG. 2 above that the container is a construct that includes all the supervisory units at several levels (typically three) for a given, virtual, or mixed device on the network. The containers of this specific construct are arranged as four trees, a first tree 70 which represents the middle PC 62, the media center 54 and its associated TV 56 and the modem 50 and router 52. Tree 70 is the main tree of the topology. Separate trees 72, 74 and 76 center on the other PCs 60 and 64 respectively and on the laptop 65. The division into trees provides a defined network topology. A network leader is chosen according to the process described above in FIG. 3 and each tree has a root interface 78.

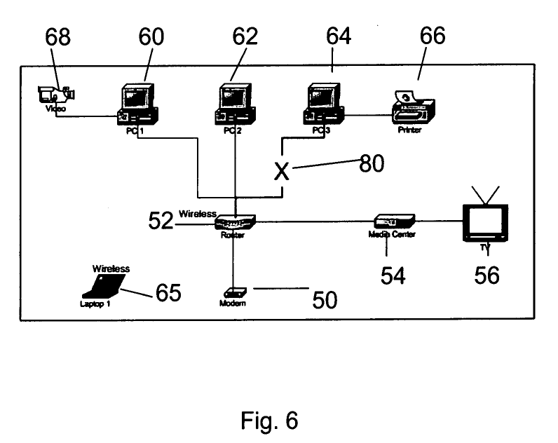

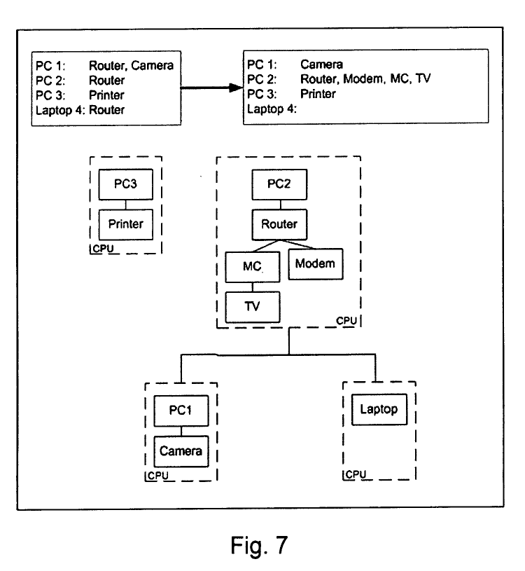

The significance of the network topology is now illustrated with respect to FIGS. 6 and 7, which are similar to FIGS. 4 and 5 respectively except that a break is introduced into the network. Parts that are the same as in previous figures are given the same reference numerals and are not described again except as necessary for an understanding of the present issue. More specifically FIG. 6 shows the same network as in FIG. 4 except that a break 80 is introduced between the router 52 and the third PC 64. FIG. 7 shows that trees 70, 72, and 76 remain connected and tree 74 is isolated but is able to continue functioning. That is to say each tree is still properly managed. Such a highly distributed nature within the supervisory layer ensures high network reliability even when one or more devices are malfunctioning.

Correction at the network in order to deal with problems such as the break shown in FIG. 6 may proceed logically from each supervisory unit to the next through the tree structure of FIG. 7. Sequencing of corrections of multiple errors takes into account the ability to reach isolated network parts using the logical network sequence where applicable. Eventually the integrity of the network is reestablished via the comprehensive reestablishment of absolute optimal preconditions and settings of each and every module on each device. Auto-correction of the local device is achieved by the individual experts, with the associated driver gathering the needed information. Then the correction propagates across the network.

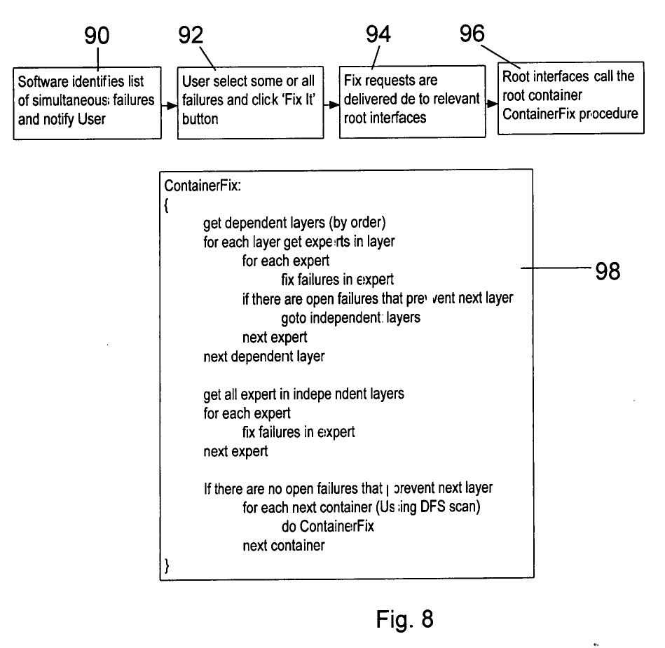

Reference is now made to FIG. 8, which illustrates a procedure for fixing an error identified by the supervisory layer. In a first stage 90 the supervisory layer software identifies a list of simultaneous failures and notifies the user. In stage 92 the user selects any of the failure notifications and requests a fix, possibly by selecting a fix option presented on the screen. In stage 94 fix requests are delivered to relevant root interfaces 78, and in stage 96 the root interfaces call a fix procedure. That is to say the fix procedure is a property of the individual container but is called by the root interface, which is typically located on the PC assigned to the local tree. In an alternative embodiment, the correction may proceed transparently to the user who is not queried.

In the user prompted embodiment discussed above, the fix request appears as a soft “fix me” key on the user's desktop (UI) when a network failure occurs. Upon user authorization, typically by clicking on an icon in accordance with the instructions on the user's screen, the failure is automatically self-repaired. This feature exists as a result of the distributed nature of information at each and every network device.

A typical container fix routine is shown in box 98.

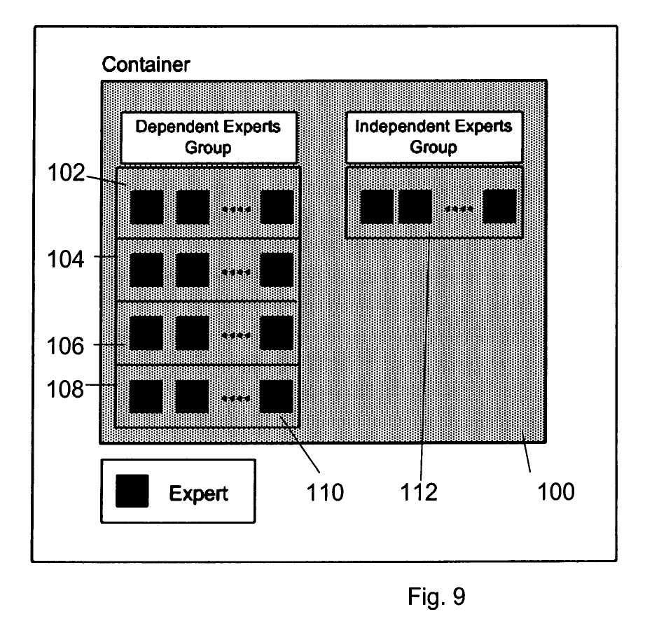

Reference is now made to FIG. 9, which is a simplified diagram illustrating the structure of a typical container 100. The diagram shows the experts of the supervisory layer only and does not show the drivers. The experts are divided into layers 102, 104, 106 and 108 and are further divided into two groups 110 and 112, dependent experts which are associated with a particular modules on the device and independent experts which are not associated with particular modules but which provide data for the container as a whole.

In a further embodiment, the present embodiments ensure that modules on the devices in the network are installed properly according to specific settings and communications standards. The embodiments may auto-configure service components such as network-related parts of PCs, modems, routers, Wi-Fi, VPN, firewall, etc. Each new device added to the network may be compared to a predefined set of optimal standard or protocol based behaviors for the device and those devices connected to it. The same principles are applied to resetting the network after any change.

In a further embodiment, when a network change occurs as a result of the addition of a new module, device or service, a change in operating system or any other network change, a display appears on the user interface of the network leader. An example would be a wireless user attempting to use the home wireless network. The information could additionally be made available to network providers, providing a new level of cause based reliability data.

In networks, a single problem may generate many symptoms that propagate through the network. Many current solutions try to handle and correlate the symptoms to localize the network fault. As each network node is locally managed, faults are detected at the source. The present embodiments obviate the need for complex symptom correlation analysis that typically will only give an estimation of the root problem.

The data model and algorithms used by the supervisory layers of the present embodiments are designed such that preferred embodiments universally support any residential or SOHO broadband service, including home networking, in the same manner. Thus, supporting the simple high speed internet access service which consist of PC and DSL or Cable modem is done exactly in the same manner as highly complex home networking services which include routers, VPNs, Firewalls, etc.

It is expected that during the life of this patent many relevant devices and systems will be developed and the scope of the terms herein, particularly of the terms “networking”, “topology”, “supervisory layer”, “node” and “protocol” is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Apparatus for supervision on a network having a plurality of network devices, the network devices having at least one module, the apparatus comprising:
supervisory layers at said network modules for supervising at least one member of the group consisting of configuration and expected behavior of a respective module, said supervisory layers configured to detect deviations from said member at said network modules.

2. The apparatus of claim 1, wherein said member comprises a communication protocol.

3. The apparatus of claim 1, wherein said member comprises standard behavior definitions.

4. The apparatus of claim 1, wherein said member comprises protocol defined behavior.

5. The apparatus of claim 1, wherein said member comprises standards customized for a network.

6. The apparatus of claim 1, wherein said member comprises module specific behavior of autonomous modules within said devices.

7. The apparatus of claim 1, wherein said supervisory layers are of modular construction comprising an expert element configured for member features common to multiple modules and a module element configured for module specific member features.

8. The apparatus of claim 7, wherein said common member features comprise at least one of the group consisting of /protocol definitions and interface standards.

9. The apparatus of claim 1, wherein ones of said supervisory layers further comprise correction units, for providing a correction to respective modules upon detecting of deviations at respective autonomous modules.

10. The apparatus of claim 9, wherein said correction units are configured to prompt a user with said correction as a recommendation.

11. The apparatus of claim 9, wherein said correction units are configured to automatically apply said correction to a respective module.

12. The apparatus of claim 1, further configured to output status reports to a user.

13. The apparatus of claim 12, further configured with a leader element and with tree nodes able to manage trees structures of other network devices about said tree nodes as autonomous structures.

14. Apparatus for supervising a module operating a protocol or interface standard to communicate with other modules, the apparatus comprising,
a supervisory layer configured about said module for supervising at least one member of the group consisting of configuration and expected behavior of said module, said expected member being defined in terms of said protocol or interface standard, said supervising behavior being configured to react to deviations from said expected member, thereby to manage said module.

15. A method for supervising a network comprising:
defining at least one member of the group consisting of configuration and expected behavior at modules on devices on said network, and
supervising conformity of said modules with said expected member on said network.
